(19) United States
(12) Patent Application Publication
(10) Pub. No.: US 2015/0180949 A1
(43) Pub. Date: Jun. 25, 2015

(54) HYBRID CLOUD ENVIRONMENT

(71) Applicant: HEWLETT-PACKARD DEVELOPMENT COMPANY, L.P., Houston, TX (US)

(72) Inventors: Stephane Herman Maes, Sunnyvale, CA (US); Rajeev Bharadhwaj, Sunnyvale, CA (US); Jerome Labat, Sunnyvale, CA (US); Thomas Goepel, Sunnyvale, CA (US)

(21) Appl. No.: 14/414,185

(22) PCT Filed: Oct. 8, 2012
(86) PCT No.: PCT/US2012/059209

§ 371 Date: Jan. 12, 2015

(51) Int. Cl. H04L 29/08; H04L 12/26

(52) U.S. Cl. CPC H04L 67/10; H04L 43/10

(57) ABSTRACT

A hybrid cloud environment, comprising a processing resource to deploy and manage an application over a number of cloud environments, a storage resource to store cloud middleware, the cloud middleware comprising a service and deployment manager to, with the processing resource, deploy an application on a hybrid cloud infrastructure, in which the application is deployed on the hybrid cloud infrastructure by matching available hybrid cloud infrastructure capabilities to an application model describing resource requirements, properties, and characteristics of the application, and a lifecycle management module to manage a lifecycle of the application and the associated hybrid cloud infrastructure.

### BACKGROUND

The use of various computing, storage and networking resources delivered as a service as well as the use higher level services like applications and platforms provided as a service has proven beneficial to a number of users. Using these resources over a network is commonly referred to as cloud computing. With cloud computing, a user may be able to grow his or her presence on a network or networks dynamically and spontaneously based on the traffic his or her services is experiencing at any given time. Additionally, a user may use the resources available to run computations, store data, and share with or provide these as a service to other users. However, creating applications for deployment on, controlling those applications on, and managing the infrastructure can be expensive and difficult to accomplish. Specifically, it may be difficult to develop a service application that will be effectively implemented on the infrastructure and platform used on the cloud to which the user wishes to deploy the application. Still further, it may be difficult to manage any individual application's lifecycle, infrastructure, domain, and the application itself in a secure manner while implemented in a cloud environment. Even further, it may be difficult to facilitate the tasks of each individual supporting or using the cloud environment such as application developers, users, IT administrators, service providers, and operations managers.

### BRIEF DESCRIPTION OF THE DRAWINGS

The accompanying drawings illustrate various examples of the principles described herein and are a part of the specification. The examples do not limit the scope of the claims.

FIG. 1 is a block diagram of a hybrid cloud environment according to one example of the principles described herein.

FIG. 2 is a block diagram of a hybrid cloud environment according to another example of the principles described herein.

FIG. 3 is a block diagram of a hybrid cloud environment according to another example of the principles described herein.

FIG. 4 is a block diagram of a hybrid cloud environment according to another example of the principles described herein.

FIG. 5 is a flowchart depicting a method of deploying and managing applications on a hybrid cloud environment according to one example of the principles described herein.

Throughout the drawings, identical reference numbers designate similar, but not necessarily identical, elements.

### DETAILED DESCRIPTION

To provide a user friendly environment where applications can be fully self-managed on a cloud environment by a number of users fulfilling different roles, the present specification discloses a hybrid cloud environment, comprising a processing resource to deploy and manage an application over a number of cloud environments, a storage resource to store cloud middleware. The cloud middleware comprises a service and deployment manager to, with the processing resource, deploy an application on a hybrid cloud infrastructure, in which the application is deployed on the hybrid cloud infrastructure by matching available hybrid cloud infrastructure capabilities to an application model describing resource requirements, properties, and characteristics of the application, and a lifecycle management module to manage a lifecycle of the application and the associated hybrid cloud infrastructure.

Even further, the present specification discloses a system comprising a service creation environment (SCE) stored on a storage resource of a cloud server associated with a hybrid cloud environment to receive input from a user to, with a processing resource, build application logic for an application, and a number of service execution environments (SEEs) stored on the storage resource of the cloud server to, with the processing resource, execute the application created by the SCE. The application logic comprises logic that causes the application to self manage its lifecycle while deployed on the hybrid cloud environment and the application relies on APIs, events, and resources provided by cloud middleware distributed throughout the hybrid cloud environment.

Still further the present specification discloses an event-driven architecture on a hybrid cloud, comprising a message broker stored on a storage resource of a cloud server associated with a hybrid cloud environment to send and receive messages to and from individual resources distributed within and across a number of clouds in the hybrid cloud environment. Each resource may be distributed within and across the number of clouds in the hybrid cloud environment are treated as an end point.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the terms “cloud” or “cloud environment” are meant be understood broadly as the provision of, through any computer environment, resources as a service. These resources may include, but are not limited to, physical computing hardware devices such as processors, storage devices, and network devices; computing platforms in the form of computer usable program code; application software in the form of computer usable program code; computer data storage being provided as a service; network platforms being provided as a service; application program interfaces in the form of computer usable program code; production, staging and testing environments being provided as a service, security platforms and computer usable program code being provided as a service, among others. Specific forms of a cloud may include, a public cloud, a private cloud, a managed cloud (hosted or on premises), and any combination in which two or more of the above types of clouds are bound together and offer the advantages of the number of types of clouds involved (e.g., a hybrid cloud).

Additionally, in the present specification and in the appended claims, the term “middleware” is meant to be understood broadly as a system that, in one example of the present specification, may be an architecture layer that facilitates the creation, deployment, execution testing and lifecycle management of applications distributed on a cloud environment. In another example, the middleware facilitates the management of the lifecycle (e.g., manage the building, provisioning and deployment, execution, ongoing management, reporting, metering, retiring and so forth) of existing cloud services and combinations of existing cloud services on the cloud environment. The middleware may further provide additional advantages as will be described in more detail below.

Additionally, in the present specification and in the appended claims, the term “application” is meant to be understood broadly as a collection of components. In addition, the application can be characterized for each of its components by a set of artifacts (e.g., installer, code, executable, configurations and so forth, and a set of components that are installed, executed and interact with each other (e.g., executable, middleware (MW), databases, operating system (OS), and so forth).

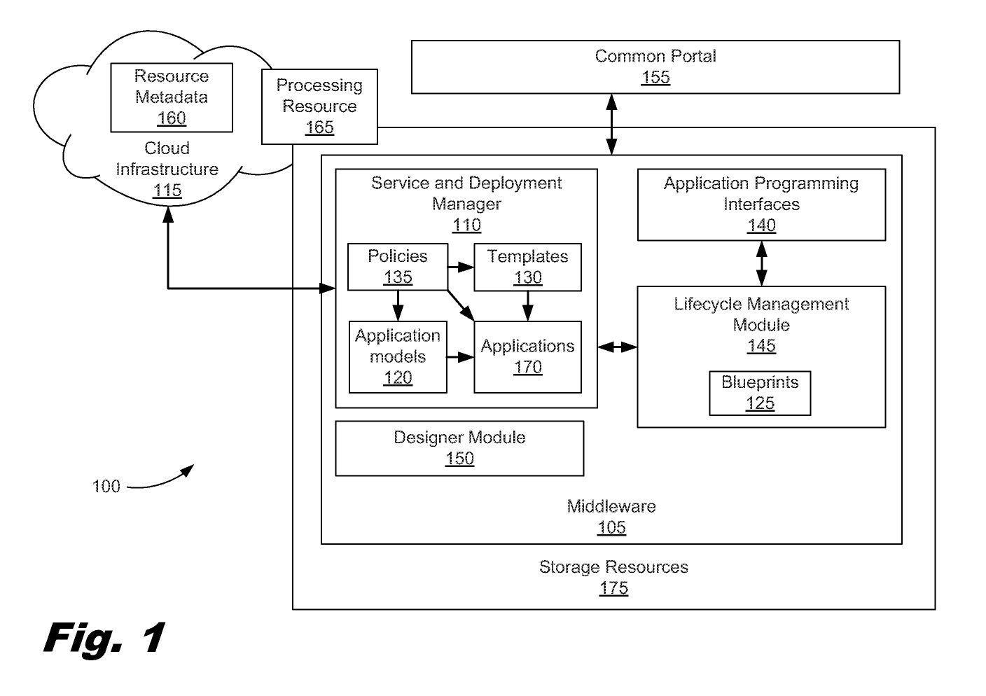

Turning to FIG. 1, a block diagram of a hybrid cloud environment (100) according to one example of the principles described herein. In the example of FIG. 1, the cloud environment may be a hybrid cloud wherein a number of different cloud environments are bound together offering the benefits of those cloud environments included to the hybrid cloud structure. For ease of explanation, therefore, the present specification will be described in terms of using the present middleware in a hybrid cloud environment. However, this is not meant to limit the description and the present specification contemplates the use of the middleware in any number and type of cloud environment.

As discussed above, the hybrid cloud environment (100) may comprise any type of cloud resources and services and may further include any number or combinations of those types of clouds. Therefore, although FIG. 1 depicts a hybrid cloud environment, the present specification contemplates that the middleware (105) described in connection with the hybrid cloud (100) herein may be distributed, stored and operated over any number and type of hybrid clouds. Additionally, the present specification contemplates that any number of middleware instances may exist on any number of cloud environments with each middleware instance capable of completing the tasks described below as well as communicating with other middleware (105) instances over the number of cloud environments.

As will be described in more detail below, the hybrid cloud environment (100) comprises a number of application programming interfaces (140). The middleware (105) described herein is used to help orchestrate the use of the APIs (140) such that a number of applications and services deployed on and throughout the hybrid cloud environment (100) manage their own lifecycles. The application programming interfaces (140) may use data stored on a storage resources (175) within the hybrid cloud environment's (100) infrastructure to help the applications to manage their lifecycles. This data may comprise policies (135), templates, (130), resource metadata (160), application models (120) and blueprints (125). Still further, the hybrid cloud environment (100) may further include cloud infrastructure (115) which may comprise processing resources (165) and storage resources (175) which further allows the cloud middleware (105) to store and execute computer readable programming code associated with the data. The hybrid cloud environment (100) will now be described in more detail.

The processing resource (165) may be used by cloud middleware (105) to execute code in order to complete the computational goals of the middleware (105) as described below. These processing resources (165) are included as part of the hybrid cloud environment's (100) infrastructure. The processing resource (165) may include any number of processors which may be distributed across any number of cloud environments of the hybrid cloud environment (100). In one example, the processing resources (165) may comprise a number of processors communicatively coupled together on a single cloud environment within the hybrid cloud environment (100). The processing resource (165), through the use of the middleware (105), may also facilitate the user to create, deploy, and manage a number of applications deployed on the cloud infrastructure (115).

The storage resources (175) may also be included as part of the hybrid cloud environment's (100) infrastructure and may be used by the processing resource (165) and middleware (105) to store data so as to achieve the goals by the middleware (105) and user as described below. Additionally, the storage resources (175) may be used to store the instances of the middleware (105) on the number of cloud environments within the hybrid cloud environment (100) as well as store the above mentioned data as a data-as-a-service resource. The storage resources (175) may comprise any type of storage device including, but not limited to, an electrical connection having a number of wires, a portable computer diskette, a hard disk, a random access memory (RAM), a read-only memory (ROM), an erasable programmable read-only memory (EPROP or Flash memory), an optical fiber, a portable compact disk read-only memory (CD-ROM), an optical storage device, a magnetic storage device, or any suitable combination of the foregoing. Even further, the storage resource (175) may be comprised of any number and type of storage device communicatively coupled together. Still further, these storage resources (175) may be integrated throughout the number of cloud environments within the hybrid cloud environment (100).

As mentioned, the hybrid cloud (100) comprises middleware (105). The middleware (105) provides automated deployment of applications (170) by determining infrastructure hardware and capabilities of the infrastructure (115) within the hybrid cloud (100). The middleware (105) also determines application requirements of the various applications deployed on the infrastructure (115) by analyzing an application model (120). The middleware (105) may use a service and deployment manager (110) to service and deploy the various applications on the infrastructure of the hybrid cloud (100). The function and features of the service and deployment manager (110) may be at least partially realized by the deployment manager described in PCT patent application No. PCT/US2012/041625, the subject matter of which is incorporated herein by reference. As briefly described above, the number of instances of middleware (105) may be stored on and throughout the number of cloud environments of the hybrid cloud environment (100) using storage resources (175) distributed on the individual cloud environments of the hybrid cloud environment (100). In one example, the computer program code defining the middleware and the modules associated with the middleware can be an installed instance of the middleware (105). In another example, the computer program code defining the middleware and the modules associated with the middleware can be provided within the cloud middleware (105) as an installation pack. In these two examples, the storage resources (175) may be a server storage from which the installation pack can be downloaded to or the storage resources (175) may be a storage device memory on which the computer readable program code is installed.

The application models (120) may define resource requirements, properties, and characteristics of an application (170). In one example an application model (120) can include a topology model describing which application components should be deployed and how those application components are to be deployed (e.g., what component to be deployed at which location in the cloud) for a given application (170). The application model (120) further defines the resources required to deploy the application (170) on the cloud. Here, the topologies may describe the relationships among the application's (170) components as well as the relationships between the applications (170) and the infrastructure within the hybrid cloud (100). The topologies may be reused for later applications which may comprise similar characteristics of other applications (170) deployed on the hybrid cloud (100) and may therefore be stored on a storage resource (175) for later use.

The topologies may also be kept instantiated and reused on existing infrastructure resources (e.g., in the selected topology/template (130)) across a number of applications (i.e. when new applications instances are deployed and tom off of the same infrastructure). In this way, the middleware (105), and more specifically, the service and deployment manager (110), may more easily direct the matching of the application models (120) and infrastructure templates (130) or infrastructure topologies to deploy an application (170) on the hybrid cloud (100).

Still further, the application model (120) may define recipes used for provisioning and managing the application's (170) lifecycle (e.g., recipes describing how and when to monitor feedback from a deployed application and how and when to adjust the infrastructure resources based on such feedback). The recipes may include references to a number of artifacts used to execute the recipes such as installation scripts, code to compile the recipes, etc. The recipes may also be stored on the storage resource (175) of the cloud infrastructure (115). In one example, the topology may be expressed in a standard language and model such as that described in Topology and Orchestration Specification for Cloud Applications (TOSCA) by Oasis®.

The templates (130) may describe the capabilities and features of the infrastructure associated with the hybrid cloud (100). Specifically, the templates may use resource metadata (160) defining the hardware, software, and firmware distributed throughout the hybrid cloud (100) to present as potential resources the application (170) may be run on. The resource metadata (160) may be stored on the storage resources (175) of the hybrid cloud environment (100) and may change as storage resources (175) and processing resources (165) as well as other resources on the hybrid cloud environment (100) change.

The policies (135) may describe a number of operating contexts for any given application. For example, the policies (135) may describe when to operate the application and on what servers geographically located in the world the application is to be operated. The policies (135) may further contain information on how to maintain load balancing on the servers it is operating on, which network domain the application is to be deployed on, monitoring requirements (e.g. whether the load is between specified limits on the server), if there are any security issues, and ensure there are no upcoming maintenances within a given period of time. The policies (135) may further describe how to decide which server to place a computing load onto based on prices considerations of operating on that server. The policies (135), when they are detected, may also decide how to react to monitoring or security events.

Even further, the policies (135) may describe any security issues that may arise in connection with placing a load on a server within a specific cloud environment. In this example, the policies (135) may dictate which portions of the application are operated on which type of cloud environment so as to protect confidential data or any backend services provided by the application being executed. Other policies may be defined as well that may further describe when, where, and how the application is to be operated.

Together the application models (120) and templates (130) are matched together (either manually by a user or automatically via the service and deployment manager (110) and policies (135) using a number of algorithms) to describe on what infrastructure the applications (170) should be run on and may be used to dynamically (or statically) optimize and bind infrastructure resources (characterized by metadata properties) to the applications (170). In one example, the policies (135) may be used to help match the application models (120), which describe the needs of the application, with the templates (130), which describe the available resources on the hybrid cloud (100).

In one example, the application models (120) and templates (130) may be expressed as topologies. The topologies can be implemented to express (with action details) where a common application model (120) may be used to deploy a number of different applications (170) on the hybrid cloud (100). Here, because the application (170) is already designed through the use of the application model (120), the application (170) can be transferred to another cloud without re-coding the application to do so. In this case, it is reinstantiated on the new environment in the new context using the topology required to do so. Therefore, the application (170) may be moved across heterogeneous cloud environments (e.g. from one operating system to another or from one hypervisor to another etc.).

Additionally, according to one example, a common portal (155) may provide a user with the ability to manage and secure the applications deployed on the various hybrid clouds (e.g., 100) at once. Through the common portal (155) a user may view the activity of all applications over all hybrid clouds (100) in one common place. In one example, a user may also use the common portal (155) to match application models (120) to templates (130) manually.

In another example, a user may view and potentially edit the automatic matching of application models (120) to templates (130) conducted by the middleware (105). In operation, therefore, the middleware (105) may implement a processing resource (165) to process policies (135) defining how the application models (120) are to be matched with the templates (130) for deployment of the application (170) onto the hybrid cloud (100). The middleware (105) may further process the resource metadata (160) that describes cloud (100) resources for a cloud (100) to create the templates (130) used. The middleware (105) may also cause application models (120) and templates (130) to be matched to determine an operating topology for the given application on the hybrid cloud (100). The matching of the application model (120) to the resources available on the hybrid cloud (100) results in the middleware (105) binding these resources to the application (170). As will be described in more detail later, the binding of these resources allows the middleware (105) to set aside those resources for that application (170) specifically throughout the lifecycle of the application (170). Still further, the middleware (105) may deploy the given application (170) based on the determined deployment conditions for the cloud (100).

In one example, the middleware (105) may further manage or monitor (event based or by query monitoring/management systems) feedback from the given application (170). For example, the middleware (105) may monitor feedback received from monitoring systems that are setup along with the applications (170) (as part of the recipes defined by the applications models or the policies) and utilize it for scaling up or scaling down resources used by the application (170); starting/stopping the application (170); moving applications (170); starting remediation (in case of failure—restoring (e.g. when session based) or moving application and redirecting traffic); or support flows to repair detected issues. A lifecycle management module (145) can be used with the service and deployment manager (110) to read feedback from the given application and enable the service and deployment manager (110) to adjust aspects of the given application or increase/decrease infrastructure resources provided for the operation of the application. This can, for example, be specified via policies (135) or other logic that describes how to handle the events and use the middleware (105) to perform the necessary changes.

The middleware (105), through the lifecycle management module (145) and the service and deployment manager (110) may further offer and deliver services to manage the lifecycles (e.g., manage the building, provisioning and deployment, execution, ongoing management, reporting, metering, retiring and so forth,) of existing cloud services and combinations of existing cloud services for end users. More particularly, as disclosed herein, the middleware (105) orchestrates the use of application programming interfaces (APIs) (140) of existing cloud services for managing the lifecycles of the existing cloud services and combinations of the existing cloud services for users of user end systems using blueprints (125). Therefore, the function and features of the service and deployment manager (110) may also be at least partially realized by the service delivery module described in PCT patent application No. PCT/US2012/045424, the subject matter of which is incorporated herein by reference.

The blueprints (125) may set forth structured plans of automated actions for instantiating and configuring the cloud capabilities that may be offered in the cloud (100). Therefore, the blueprints (125) may be set of workflows/recipes/scripts that correspond to particular lifecycle management actions that may be performed to orchestrate the APIs (140) of the appropriate cloud resources for purposes of managing the lifecycle of a given application. In one example, the blueprints (125) may be used to describe the application model. Additionally, the blueprints (125) may be used to direct how the system will act (i.e. scale up/down and scale in/out). In this example, once the resources provided to the application have changed, network traffic may need to be rerouted accordingly. In another example, the blueprints (125) may describe how the hybrid cloud (100) is to provide access to various databases within the hybrid clouds (100).

A number of application programming interfaces (APIs) (140) may be provided to allow for a communication interface between the various components of the cloud (100). Each API (140) may comprise specifications for routines, data structures, object classes, and variables. The APIs (140) may be used by the lifecycle management module (145) to help manage the lifecycle of the application.

A designer module (150) may be used by a user to help design the policies (135), templates (130), blueprints (125), and application models (120) to be implemented on the cloud (100). Specifically, a user may use the designer module (150) to define and configure the code and metadata used for deploying and running the application (170) on the hybrid cloud (100). A common portal (155) can be employed by the user to access the designer module (150) to define the policies (135), templates (130), and blueprints (125) for any given application. In one example, however, the middleware (105) may automatically define some or all of the policies (135), templates (130), and blueprints (125) for a given application, thereby relieving the user of having to enter in this information and deciding on the best policies (135), templates (130), and blueprints (125) to use. Using the designer module (150), cloud services lifecycle management can be defined independently of the resources needed to implement them. The application model (120) associated with the application to be deployed contains information such as resource capabilities, software version needed, service quality, and security policies selected and integrated into the application model (120) through the use of the designer module (150).

As briefly discussed above, a lifecycle management module (145) may also be included on the middleware (105). The lifecycle management module (145) may use the blueprints (125) to orchestrate life cycle management of services in the hybrid cloud (100). In one example, the lifecycle management module (145) may schedule lifecycle operations where current application deployments have changed from their initial deployment status due to the lifecycle operations. For example, as part of a scheduled lifecycle operation, an application could be moved, copied, or retired (or its associated components/artifacts may be moved, copied, or retired) as part of a lifecycle operation performed by the lifecycle management module (145). In one example, the application could be moved, copied, or retired (or its associated components/artifacts may be moved, copied, or retired) upon detection of an event. The event can be monitored for by the lifecycle management module (145) and the blueprints (125) may comprise information on how to react to these detected events. The lifecycle management module (145) may interact with and through the service and deployment manager (110). Again, the determination on how to react to these detected events may be encoded in policies (135) or logic that also drives the way that the middleware (105) reacts.

Workload management (e.g., automatic scaling up/down and scaling in/out of infrastructure resources as well as optimal deployment of resources made available in the hybrid cloud (100)) can also be provided by the middleware (105). For example, based on the load of any given server or resource (or resource pool/cloud) on the hybrid cloud (100), a scale out/scale in or a move of the application to another location (another resource pool/cloud or combination of clouds) operation may be performed based on policy criteria operation. This may be done in response to monitoring events or feedback received by the lifecycle management module (145) or based on a request made through a number of APIs to such monitoring systems. In one example, the application model (120) or blueprints (125) can describe how to deploy (or tear down/un-deploy) an application in a portion of the cloud infrastructure (115) utilized for deployment of a given application. For example, the application model (120) or blueprints (125) can identify infrastructure (115) resources and what is needed from the cloud infrastructure (115) for deployment or retirement of the given application. A user or designer may be allowed to change the blueprints (125) and/or application model (120) for a deployment of the application (170). Such a change in deployments can be achieved on another cloud configuration (e.g., from a private cloud to a public cloud) to provide the desired information to execute the application on the different configuration even if the cloud is based on different APIs, network resources, and so forth. Example reasons for moving an application across different deployments can include load balancing, moving from private to public configurations or vice versa, increasing or decreasing resources for the application, and scaling the application up or down across different infrastructure resources, for example. Again, the determination on how to react to these detected events may be encoded in policies (135) or logic that also drives the way that the middleware (105) reacts.

The middleware (105) may further provide for automated test management, staging, and deployment for applications. Specifically, the middleware (105) may configure and launch a test suite of application deployments for any given application via the service and deployment manager (110). The middleware (105) can configure a plurality of tests associated to a plurality of different operational deployment scenarios for the application. The configuration and resultant application deployments can be administered across organizational cloud boundaries to suit various organizational needs. For example, development may have one set of needs and production may have a separate set of needs. In some cases, public deployments for the application are configured and launched and in other cases, private deployments are launched. In other cases, a combination of public and private deployments are launched as configured by the middleware (105) and deployed via the service and deployment manager (110).

The middleware (105) enables automated development testing, development for operations, and application security development, for example, based on determining best matching infrastructure by matching of application models (120) to infrastructure models as specified by the resource metadata (160). Application models (120) can be specified for specific deployments or tests. Selecting which model (120) to use can be achieved by selecting from different models in a set of models or via matching of a label associated to different model types specified in the policies (135), for example. In one example, the middleware (105) may automatically select which application model (120) is to be matched with the best suited templates and used with the application (170). In another example, a user may manually select an application model (120) to use by selecting the application model (120) from a list of application models (120) via a common portal (155).

The matching infrastructure can then be employed to support test or facilitate production staging while also running various test suites and at different stages of testing and/or monitoring at production stages. For development testing, the middleware (105) allows developers to follow development of any software with tests in the cloud (100) where they can deploy and run the application in multiple deployment scenarios and execute target test cases without the usual delays and cost to setup deployment and test. After developing and testing of software elements (e.g., applications components), they can then be deployed and operated in production (and monitored similarly). This enables also testing security aspects of the application since security can also be tested in a secure development and production environment. Feedback of bugs, security breaches and other detected events can be easily monitored and fed back to development agents such as for diagnostics and repair through the common portal (155). When problems are reported in production, the deployment conditions and context can be reproduced with a bug/problem report for developers (or support) to diagnose and correct which can then lead to test and patch/updates which can then be staged and/or tested.

Additionally, the middleware (105) may track changes in the application (e.g., to detect a version change) during a service lifecycle of the given application and, based on the detected changes, update the application requirements for deployment of the application in the cloud. For example, the middleware (105) can update the application model (120) and/or the policies (135) for the given application in accordance with the changes. Alternatively, such updating of the models (120) and/or policies (135) can also be performed manually or via a tool/logical process that people or systems can fulfill. In general, the application often migrates through many versions, deployments options, revisions, and so forth. Thus, applications, platforms, services, and policies all form a part of a service lifecycle. This service lifecycle can change over time with versions of each artifact that composes the service. The middleware (105) facilitates that components and dependencies between components of the application are deployed in the cloud in workable manner over the course of the service lifecycle.

The middleware (105) can model dependent relationships between components and artifacts of a given application which can then be updated in the application model (120) or the policy (135) based detecting changes in the given application. Still further, the middleware (105) can be employed to various stages of development, production, and/or operations with monitoring/tracking of versions and with instantiation of components during such stages in view of such monitoring/tracking. This can include monitoring of the stages and monitoring of the deployed instances via closed loop feedback while tracking changes in staged versions and initiating automated deployments in view of such monitoring.

Additionally, the middleware (105) may be programmed to specify portability instructions which can update the policy (135) and/or application model (120) for deployment of the given application on the cloud (100). Here, the middleware (105) can instruct the service and deployment manager (110) to move an application from one deployment, such as a deployment in a private cloud for example, to another deployment in the cloud (100), such as a deployment into a public cloud, for example. The middleware (105) can be implemented to include an application programming interface (API) or graphical user interface (GUI), for example, to receive the deployment request. As shown, a common portal (155) can monitor feedback from the deployments in the cloud (100) to provide information for such features as workload management (e.g., scaling application environment and infrastructure resources up or down).

In one example, the service and deployment manager (110) provides a multitenant architecture. In one example, the service and deployment manager (110) may provide a multitenant architecture in which a single instance of the service and deployment manager's (110) applications (170) serves multiple organizations. The service and deployment manager (110) may provide a multitenant architecture in which cloud services may be segmented among different tenants, which means that the application (170) interaction and data are securely segregated among the tenants. Stated differently, one tenant does not, in general, access, use, see or impact the data, applications and/or impact the performances of another tenant. The policies (135) and blueprints (125) may set out if and when to create new instances of the application (170) on the hybrid cloud (100). For example, if the activity of one tenant impacts the performance of another tenant the policies (135) and blueprints (125) may help determine if another instance of the application (170) should be made on the hybrid cloud (100) and where and with what resources that should be implemented. In general, the multitenant hybrid cloud services are offered in ways that are secure, auditable, resilient, and so forth.

Blueprints (125) may also be associated with a multitenant application to orchestrate a number of APIs to manage the lifecycle of the application. The function and features of the middleware (105) may be, for example, realized by the system described in PCT patent application No. PCT/US2012/045433, the subject matter of which is incorporated herein by reference.

In another example, the middleware (105) may oversee the orchestrating of APIs associated with constituent clouds of a hybrid cloud for purposes of allowing at least one cloud resource management function to be performed across two or more of the constituent clouds. More specifically, a first interface may be provided to manage cloud services provided by hybrid cloud resources that form a hybrid cloud. In this manner, the first interface is used to orchestrate the cloud services, including using the first interface to orchestrate APIs to allow at least one cloud resource management function to be performed across at least two of the cloud resources. The orchestration of the APIs manages functions across the cloud services for users of a user end systems (desktops, portable computers, smartphones, clients, thin clients, servers, and so forth). The function and features of the middleware (105) may be at least partially realized by the system described in PCT patent application No. PCT/US2012/048991, the subject matter of which is incorporated herein by reference.

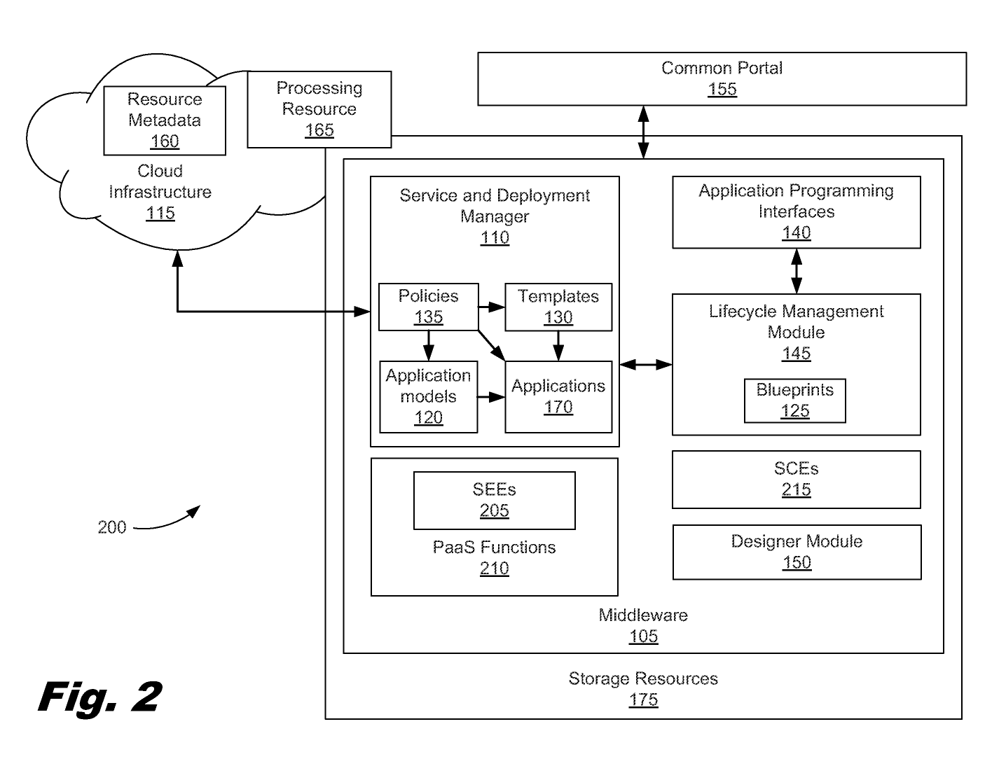

Turning now to FIG. 2, a block diagram of a cloud (200) is shown according to another example of the principles described herein. Beyond the features of the cloud (100) described in FIG. 1, the hybrid cloud (200) may further include a service execution environment (SEE) (or a combination of multiple SEEs written in java, C#, Python, Rubby, PHP, Node. js, among others) (205) running on the middleware (105) and taking advantage of a number of platform as a service (PaaS) functions (210) that the middleware (105) provides. A service creation environment (SCE) (215) may also be included in the cloud (200) to develop applications in or across SEEs and take advantage of the PaaS functions.

Among the advantages enabled by the present application, the middleware (105) provides capabilities for the SEE (205) to be exposed as part of the programming model allowing the application deployed on the cloud (200) to self manage its lifecycle. For example, the application (170) may be able to listen and react to monitoring events and taking lifecycle management decisions (e.g. policy based or internal application logic) by performing remediation task as discussed above such as scaling, moving, or calling APIs of blueprints (125) affecting its state. Additionally, with the SEE (205) exposed, the application (170) may react to monitoring events even with regard to registration and handling. Still further, having the SEE (205) exposed, the application can react to query events on its own.

In the hybrid cloud (200) of FIG. 2, the application may incorporate policies (135), templates (130), application models (120), topologies, and blueprints (125) previously determined to be able to manage the lifecycle of the application into its code. In this way, the application may be provisioned and deployed by a user using these policies (135), templates (130), application models (120), topologies, and blueprints (125) and, if and when the application encounters lifecycle management issues (or monitoring events), the application (170) may be notified of these issues. However, the application (170) may take those steps necessary to prevent the issue from occurring or remediating them when they take place. For example, if the application (170) needs to be scaled up or out to consume additional cloud resources, the application (170) may simply choose, via the policies (135) how to do so. The templates (130) and blueprints (125) may further allow the application (170) to choose which physical hardware on the cloud (200) to scale out or up with.

The PaaS functions (210) along with the SEEs (205) and SCEs (215) may serve as a programming model. In this case, the user, acting as an application (170) developer, may determine to any extent when and how to react to specific monitoring events as described above. Additionally, the PaaS functions (210) may be implemented over any and all types of clouds to which the application has access to. As such, the application (170) developer may take advantage of any resources across any number of cloud environments.

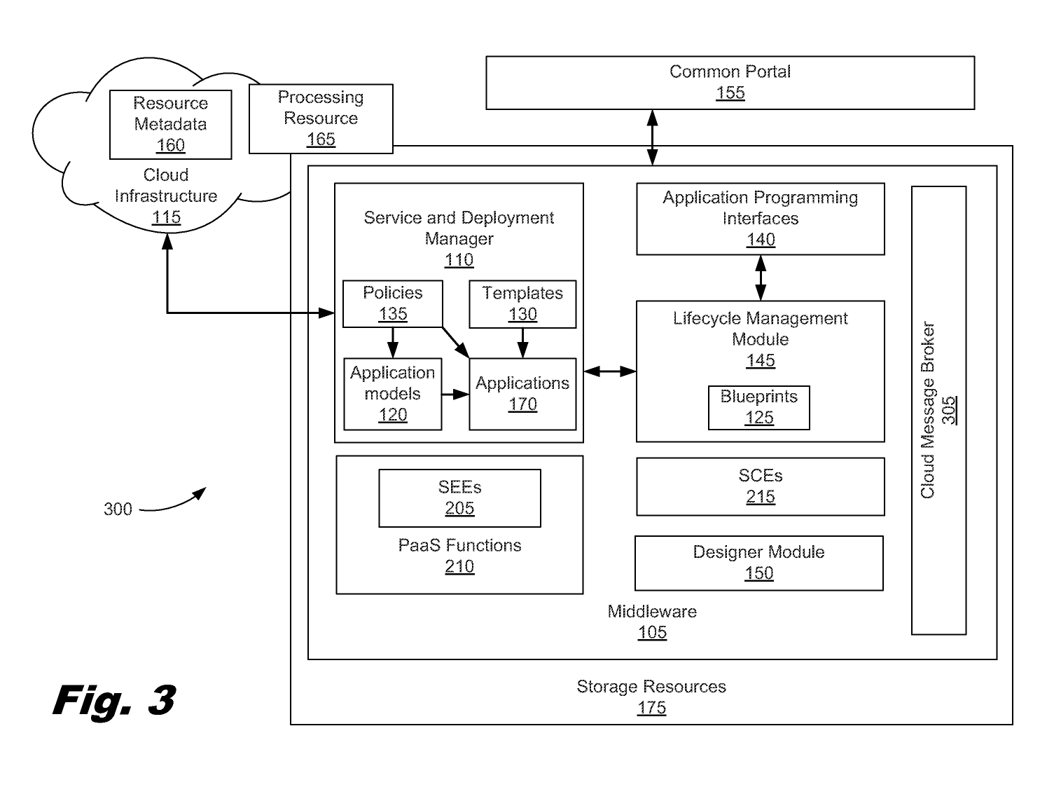

FIG. 3 is another hybrid cloud (300) represented as a block diagram according to yet another example of the principles described herein. Here the hybrid cloud (300) may further include a cloud messaging broker (305). As discussed above, the present specification describes situations where the middleware (105) may involve a number of cloud services operated over a number of hybrid clouds which may be public, managed, or private clouds, for example. The cloud message broker (305) in this case allows messages to be transferred between individual components of an application or resources spread over these cloud environments.

In one example, an event-driven architecture may be used to promote the production, detection, consumption of, and reaction to certain events. In this example, a simple notification service (e.g. SNS) and simple queue service (e.g. SQS) may be used in conjunction with an API (140) such as Websocket® developed by W3C® and IETF®. Here, instead of a cloud message broker being purely http language based, in the message broker (305) Websocket® is used. A notification about a change in a hybrid cloud (300) may be sent across the different clouds by first sending a notification over the simple notification service (SNS). The notification may indicate that a message is available for viewing. The message is then queued in the simple queue service (SQS) where it can then be retrieved. In one example, the programming code defining the Websocket® application may have additional code added to it that allows the SQS to add a number to the message packet. A notification may then be sent to an intended recipient. Because each middleware (105) component may be deployed as end points on the messages broker (305), each component may use the message broker to provide other components with information regarding changes being made within the cloud infrastructure (115) due the to application (170) managing its lifecycle. The extensions may also provide for the capability to request within WebSocket® that a packet having a certain number associated with it be re-sent. In one example, if the message is intended for multiple recipients, then a separate queue may be created for each recipient.

In the example above, because the cloud message broker (305) uses Websocket®, bidirectional connectivity between clouds may be realized. Additionally, with the features of Websocket®, it can be guaranteed that delivery of the notification and message will be sent and received. Further, messages may be transferred in real time using SNS, SQS and Websocket®.

Because the middleware (105) comprises a number of components, these components may be allowed to communicate with each other by sending messages via the message broker (305) over the hybrid cloud (100, 200, 300). As such, the middleware (105) may be set up as an event driven architecture which promotes the production, detection, consumption of, and reaction to events. In one example and as mentioned previously, the middleware (105) SCE (215) may produce code for an application that allows the application and its components distributed over the hybrid cloud (100, 200, 300, 400) to self manage its lifecycle. Therefore, when an event occurs, for example when the application determines that it is necessary to scale out, the cloud message broker (305) may be used by the application to notify the user, the middleware (105) and the other components of the application that a scale out procedure is going to take place and that certain resources are now going to be consumed by the application. In one example, this allows the user to see what resources have been consumed by the application as well as throughout the entire hybrid cloud (100, 200, 300, 400). This further allows other components of the application to react appropriately according to their policies (135), templates (130), and application models (120).

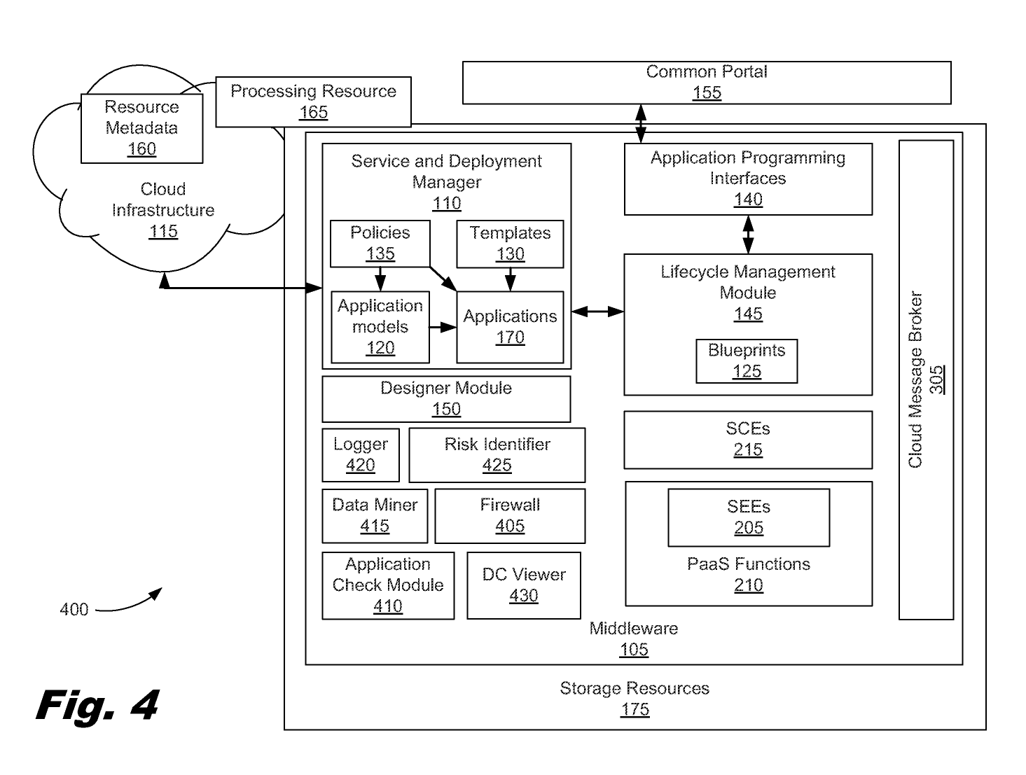

FIG. 4 is a block diagram of a hybrid cloud (400) according to another example of the principles described herein. In this example, the hybrid cloud (400) may comprise a number of additional modules used to securely operate the cloud (400). The hybrid cloud (400) may include a firewall (405), an application check module (410), a data miner (415), a logger (420), a risk identifier (425) and code vulnerability scanner, and a data center viewer (430). Each of these will now be described in more detail.

The firewall (405) may inspect each packet (e.g. deep packet inspection) coming into the cloud (400). Therefore all traffic going to any of the modules within the middleware (105) is ascension checked for know security issues. One example of the present firewall can be TippingPoint® by Hewlett-Packard Company®. A user may be notified of any particular results of the filtering of traffic via the common portal (155). Additionally, the firewall can be deployed as part of the blueprints (125) and/or templates (130).

The data miner (415) may mine any type of logs created by the middleware (105) for data that are indicative of problems within the cloud (400). In this case, the middleware (105) may cause a number of modules operating and associated with the middleware (105) to output logs to the data miner (415) via, for example the logger (420) (e.g. HP Logger®). The logs may be output in a specific format so that the data miner (415) may read those logs. In one example, the format may be common event format (CEF). These logs and the output from the data miner (415) may also be displayed on the common portal (155) for an administrator or user to view. In one example, the data miner (415) may be in the form of a product called ArcSight® developed by Hewlett-Packard Inc.®.

The risk identifier (425) may provide real-time graphical and report-based identification of risks to cloud environments and infrastructure. Data may be aggregated from other modules associated with the middleware (105) and presented to a user or administrator via the common portal (155).

The application check module (410) may search for known issues associated with applications and code operated by or associated with the middleware (105). Here, the code is searched for known security issues and, in one example; the application check module (410) checks the code of individual applications before they are deployed on the cloud (400). Doing this will assure that the code associated with the applications has no industry known issues which may cause it not to function or cause the cloud (400) to function in an undesirable way. Again, alerts may be presented to a user or developer through the common portal (155) notifying him or her that the code associated with the developed application needs to be checked. In one example, the application check module (410) may be in the form of a product called Fortify® developed by Hewlett-Packard Inc.®. The application check module (410) may also monitor the application for attack behavior or weakness patters and as a result return events to the middleware (105) or the application (170) that can react by adjusting policies or self managing its behavior respectively (e.g. by closing ports, preventing traffic, moving to another address, isolating itself, etc).

The middleware (105) may further include a data center viewer (430). The data center viewer (430) allows a user or administrator to see all available resources and resource pools as well as any possible new resources via the common portal (155). In this case, the data center viewer (430) tracks the state of every instance of hardware, software, and firmware deployed on the cloud (400) as well as all managed instances and security status of all resources and resource pools across multiple cloud environments. Therefore, as an example, through the data center viewer (430) a user may see that because their cloud (400) extends into a public cloud, that there are additional resources (i.e. data storage, data processing, data applications) available for their services to use if and when those services need to be scaled out/up from their current state.

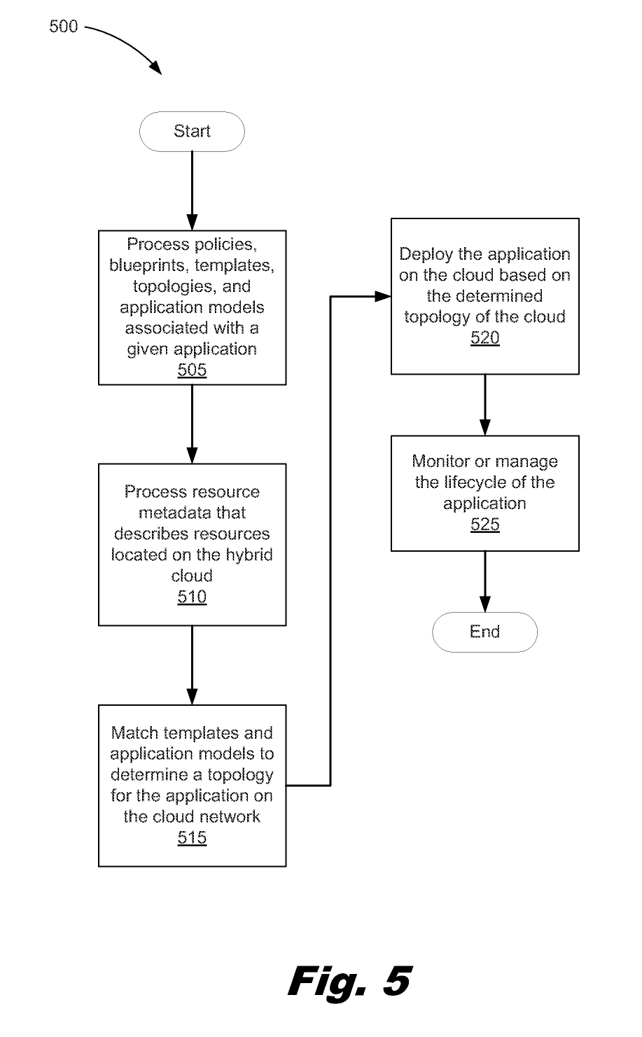

FIG. 5 is a flowchart depicting a method (500) of deploying and managing applications on a hybrid cloud (100) according to one example of the principles described herein. The method (500) may begin with the middleware (105) processing (505), with the processing resource (165), the policies (135), blueprints (125), templates (130), topologies and application models (120) associated with an application (170). Metadata associated with the resources of the hybrid cloud (100, 200, 300, 400) are then processed (510). During the processing (510), the middleware (105) may determine which resources are available for the deployment of the application onto the cloud (100, 200, 300, 400) and describe those resources in the templates (130).

The templates (130) are then matched (515) with the application models (120) to determine a topology for the application (170) on the hybrid cloud (100, 200, 300, 400). Here, those resources that are available to the application for deployment on the cloud (100, 200, 300, 400) are bound to the application (170) so as to provide infrastructure to the application (170) upon deployment.

The application may then be deployed (520) on the hybrid cloud (100, 200, 300, 400) based on the topology determined to be available which was bound to the application (170). After deployment, the application's lifecycle may be monitored (525). In one example, the lifecycle management module (145) may monitor (520) the application's lifecycle as described above. In another example, the policies (135), blueprints (125), and templates (130) may define for the application how the application is to monitor itself. Therefore, as described above, the code associated with the policies (135), blueprints (125), and templates (130) allow the application to, when presented with an issue, resolve that issue without having to rely on the middleware (105) to fix these issues. Again, as described above, the application (170) may be able to listen and react to monitoring events and taking life cycle management decisions (e.g. policy based or internal application logic) by performing remediation task as discussed above such as scaling, moving, or calling APIs of blueprints (125) affecting its state. Additionally, with the SEE (205) exposed, the application (170) may react to monitoring events even with regard to registration and handling. Still further, having the SEE (205) exposed, the application can react to query events on its own.

The present specification further contemplates a computer program product for deploying and managing applications on a hybrid cloud (100, 200, 300, 400). The computer program product comprises a computer readable storage medium comprising computer usable program code embodied therewith. The computer usable program code may comprise computer usable program code to, when executed by a processing resource (165), processes (505) policies (135), blueprints (125), templates (130), and application models (120) associated with an application (170). The computer usable program code may further comprise computer usable program code to, when executed by a processing resource (165), process metadata associated with the resources of the hybrid cloud (100, 200, 300, 400). The computer usable program code may also comprise computer usable program code to, when executed by a processing resource (165), determine which resources are available for the deployment of the application onto the cloud (100, 200, 300, 400) and describe those resources in the templates (130). Still further, the computer usable program code may comprise computer usable program code to, when executed by a processing resource (165), match a number of templates (130) with the application models (120) to determine a topology for the application (170) on the hybrid cloud (100, 200, 300, 400). Even further, the computer usable program code may comprise computer usable program code to, when executed by a processing resource (165), bind resources available on the hybrid cloud (100, 200, 300, 400) to the application (170) so as to provide infrastructure to the application (170) upon deployment.

The computer usable program code may comprise computer usable program code to, when executed by a processing resource (165), deploy the application (170) on the hybrid cloud (100, 200, 300, 400) based on the topology determined to be available which was bound to the application (170). The computer usable program code may also comprise computer usable program code to, when executed by a processing resource (165), monitor the lifecycle of the application (170).

The specification and figures describe cloud middleware operating on a cloud. The cloud middleware may comprise a service and deployment manager and a lifecycle management module to provide for the creation, deployment, and lifecycle management of applications over a hybrid cloud. This cloud middleware may have a number of advantages, including a providing an automated and orchestrated environment in which the application deployed on the hybrid cloud is configured such that it will manage its own lifecycle once deployed thereby allowing a cloud administrator to test and alter the code defining the application so that the application may dynamically react to events within the cloud in the appropriate manner. Additionally, the present cloud middleware provides for the secure development and deployment of the application onto the hybrid cloud. Even further the cloud middleware allows a user to view the entire hybrid cloud in one view thereby giving the user the ability to know what resources are being consumed by an application and how best to distribute portions or components of the application over the entire hybrid cloud. The cloud middleware further provides for a more convenient application design process as the information used to conduct how and to what extent an application component is distributed over the hybrid cloud may be used later to develop and deploy other applications onto the hybrid cloud.

The preceding description has been presented to illustrate and describe examples of the principles described. This description is not intended to be exhaustive or to limit these principles to any precise form disclosed. Many modifications and variations are possible in light of the above teaching.

What is claimed is:

1. A hybrid cloud environment, comprising:
a processing resource to deploy and manage an application over a number of cloud environments;
a storage resource to store cloud middleware, the cloud middleware comprising:
a service and deployment manager to, with the processing resource, deploy an application on a hybrid cloud infrastructure, in which the application is deployed on the hybrid cloud infrastructure by matching available hybrid cloud infrastructure capabilities to an application model describing resource requirements, properties, and characteristics of the application; and
a lifecycle management module to manage a lifecycle of the application and the associated hybrid cloud infrastructure.

2. The hybrid cloud environment of claim 1, in which the lifecycle management module exposes a number of application program interfaces (APIs) to manage the lifecycles of the application on the hybrid cloud.

3. The hybrid cloud environment of claim 1, further comprising a cloud message broker to send and receive messages to and from individual resources or middleware services distributed within and across a number of clouds in the hybrid cloud;
wherein each resource is treated as an endpoint.

4. The hybrid cloud environment of claim 3, wherein the cloud message broker exchanges messages using simple notification services (SNS) that result in a recipient receiving the message from a simple queue service (SQS);
in which both the SNS and SQS uses an application programming interface (API) as a bi-directional message transport to ensure real-time delivery of messages.

5. The hybrid cloud environment of claim 4, in which the SQS adds a number to the message using a packet numbering extension and in which the number is used to allow the recipients to request retransmission of messages to ensure reliable delivery.

6. The hybrid cloud environment of claim 1, in which the lifecycle management module associates policies with the application to cause the application to self manage its lifecycle, the policies describing:
how the application is to react to a number of monitoring, managing, or security events, or results of a number of requests sent to management, monitoring, or security modules in the cloud middleware;
how the self managed application implements or updates the policies when reacting to the number of monitoring events; and
how the middleware is to react to the number of monitoring, managing, or security events, or results of a number of requests sent to management, monitoring, or security modules in the cloud middleware by:
calling a number of application programming interfaces (APIs) provided by the middleware as a middleware service; or
triggering a number of blueprints that manage the lifecycle of a number of cloud resources on the hybrid cloud; the triggering of blueprints resulting in a change to the lifecycle of the resources, how the application uses the resources, and how the application self manages its lifecycle.

7. The hybrid cloud environment of claim 1, further comprising:
a firewall to inspect a number of data packets entering the hybrid cloud;
an application check module to search for known issues associated with applications and code associated with the middleware;
a data miner to mine log files created by the middleware and outputted from a logger, in which the data miner searches for data that is indicative of problems within the hybrid cloud;
a risk identifier to provide real-time graphical and report-based identification of risks the hybrid cloud and infrastructure;
a data center viewer to allow a user to see all available resources on the hybrid cloud via a user interface; or
combinations thereof.

8. A system comprising:
a service creation environment (SCE) stored on a storage resource of a cloud server associated with a hybrid cloud environment to receive input from a user to, with a processing resource, build application logic for an application; and
a number of service execution environments (SEEs) stored on the storage resource of the cloud server to, with the processing resource, execute the application created by the SCE;
in which the application logic comprises logic that causes the application to self manage its lifecycle while deployed on the hybrid cloud environment; and
in which the application relies on APIs, events, and resources provided by cloud middleware distributed throughout the hybrid cloud environment.

9. The system of claim 8, further comprising a lifecycle management module in which the lifecycle management module associates policies with the application to, once executed by the service execution environments (SEEs), cause the application to self manages its lifecycle, the policies describing:
how the application is to react to a number of monitoring, managing, or security events, or results of a number of requests sent to management, monitoring, or security modules in the cloud middleware;
how the self managed application implements or updates the policies when reacting to the number of monitoring events; and
how the middleware is to react to the number of monitoring, managing, or security events, or results of a number of requests sent to management, monitoring, or security modules in the cloud middleware by:
calling a number of application programming interfaces (APIs) provided by the middleware as a middleware service; or
triggering a number of blueprints that manage the lifecycle of a number of cloud resources on the hybrid cloud; the triggering of the blueprints resulting in a change to the lifecycle of the resources, how the application uses the resources, and how the application self manages its lifecycle.

10. The system of claim 8, in which the cloud middleware further comprises a cloud message broker, in which the cloud message broker sends and receives messages to and from individual components of the application being asynchronously or synchronously distributed within and across a number of clouds in the hybrid cloud environment.

11. The system of claim 9, in which the message broker further comprises:
a simple notification services (SNS) and a simple queue service (SQS) to facilitate the exchange of messages between resources; and
an application programming interface (API), in which both the SNS and SQS use the application programming interface (API) as a bi-directional message transport to ensure real-time delivery of messages;
in which notifications about an event occurring in the hybrid cloud are received by a number of endpoints and queued by the SQS;
in which each notification receives a message packet with the message packet having a packet number associated to it by the SQS; and
in which a notification of the message is sent to an intended recipient.

12. An event-driven architecture on a hybrid cloud, comprising:
a message broker stored on a storage resource of a cloud server associated with a hybrid cloud environment to send and receive messages to and from individual resources distributed within and across a number of clouds in the hybrid cloud environment;
in which each resource distributed within and across the number of clouds in the hybrid cloud environment are treated as an end point.

13. The event-driven architecture of claim 12, in which the message broker further comprises:
a simple notification services (SNS) and a simple queue service (SQS) to facilitate the exchange of messages between resources; and
an application programming interface (API), in which both the SNS and SQS use the application programming interface (API) as a bi-directional message transport to ensure real-time delivery of messages;
in which notifications about an event occurring in the hybrid cloud are received by a number of endpoints and queued by the SQS;
in which each notification receives a message packet with the message packet having a packet number associated to the message packet by the SQS; and
in which a notification of the message is sent to an intended recipient.

14. The event driven architecture of claim 12, in which the message broker runs on middleware stored on a storage resource and executed within and across a number of clouds in the hybrid cloud.

15. The event driven architecture of claim 14, in which the middleware further comprises a service creation environment (SCE) accessible by a user through a common portal, in which the SCE receives input from a user to, with a processing resource, build application logic for an application; and
a number of service execution environments (SEEs) to execute the application created by the SCE;
in which the message broker causes notifications to be sent to effected individual resources upon detection of events occurring on the hybrid cloud.
